(19) United States
(12) Patent Application Publication
(10) Pub. No.: US 2025/0340384 A1
(43) Pub. Date: Nov. 6, 2025

(54) SORTER BELT CONTROL

(71) Applicant: Lewco, Inc., Sandusky, OH (US)

(72) Inventors: Art JENSEN, West Palm Beach, FL (US); Gerald T. GUERRA, Sandusky, OH (US)

(21) Appl. No.: 19/200,496

(22) Filed: May 6, 2025

Related U.S. Application Data
(60) Provisional application No. 63/643,383, filed on May 6, 2024.

(51) Int. Cl. B65G 47/50; B07C 3/08

(52) U.S. Cl. CPC B65G 47/503; B07C 3/08; B65G 2203/0233; B65G 2203/0283

(57) ABSTRACT

A sorter system includes a frame, a conveying surface, sensors, and a control system. The conveying surface is configured to move relative to the frame in a direction of conveyance. The conveying surface includes timing sections spaced apart from each other with known pitches between adjacent timing sections, wherein each of the timing sections comprises a marker. The sensors are fixed along a length of the frame. The sensors are configured to output trigger signals as the sensors are proximate while the conveying surface moves relative to the frame. The control system is configured to detect a first offset between a package and a particular marker, detect a second offset between the particular marker and a destination for the package, and cause the conveying surface to divert the package in a direction perpendicular to the direction of conveyance based on the first offset and the second offset.

### RELATED APPLICATION

This application claims priority to U.S. Provisional Patent Application No. 63/643,383, filed on May 6, 2024, and entitled “SORTER BELT CONTROL,” the entirety of which is incorporated herein by reference

### BACKGROUND

Conveyor systems have been used in a variety of locations, such as warehouses and distribution centers, to efficiently move or convey objects or packages, such as to prepare the objects or packages for sorting or shipment. The conveyor systems may have a conveying surface which directs packages towards a destination, such as via belts, rollers or gravity.

Sorter systems may be included in conveyor systems to direct packages into one of a plurality of locations or groups based upon an identity of the packages, such as based upon the shipping destination of the package. Sorter systems include a conveying surface that is belt-, roller-, or gravity-fed to convey the packages along the conveying surface, one or more chutes extending from one or more sides of the conveying surface, and one or more mechanisms to divert the packages into the one or more chutes. The sorter systems may be implemented at the end of the conveyor system with multiple chutes extending from the conveying surface to sort the conveyed packages, such as by shipping location. However, the sorter systems may also be used at the start or in the middle of conveyor systems, such as to divert packages between two or more conveyor paths.

A sorter system can be implemented as an activated roller belt conveyor system. A conveying surface of the activated roller belt conveyor system includes an activated roller belt. The activated roller belt conveyor system is configured to move packages conveyed along the activated roller belt into a desired chute, such that the packages may be sorted and grouped together. The chutes may be gravity fed and may include a bin or container at the end of the chute for receiving the packages. The chutes may lead to sorting areas based upon a number of features, such as the package destination (e.g., destination zip code).

Activated roller belt conveyor systems of various lengths can be included in a conveyor system. For instance, an activated roller belt conveyor system can have a length of 150 feet or longer. Additionally, activated roller belt conveyor systems commonly include activated roller belts made of plastic links. Thus, in an activated roller belt conveyor system having a length of 150 feet, a length of the activated roller belt itself is longer than 300 feet. Properties of the plastic belt are subject to many variables that change with time, such as humidity, temperature, load on the belt, wear, and stretch (e.g., due to fatigue, due to a fault event/malfunction, due to emergency stops). For example, effects of thermal expansion and contraction on a belt made of plastic links can be more pronounced as compared to a belt made of metal (e.g., steel). Moreover, it is contemplated that the properties of a belt may change in less than an hour; according to an illustration, if a dock door is left open, heat and humidity from the environment can cause the plastic belt to expand, thereby detrimentally impacting sortation accuracy. When belt properties change, control of the belt becomes more difficult as does the tracking of packages conveyed on the belt. Moreover, longer belts are prone to intermittent surging, which leads to undesired package motion on the belt.

Another type of sorter system is a cross belt sorter system. A conveying surface of the cross belt sorter system includes a plurality of carriages. The carriages are positioned in a loop. The carriages can be coupled to a drive belt, a drive chain, or the like (or a plurality of drive belts, drive chains, etc.), which cause the carriages to move in a direction of conveyance along a length of the cross belt sorter system. The carriages can include a top surface configured to move in a direction perpendicular to the direction of conveyance across the width of the cross belt sorter system (e.g., the top surface can be moved to divert a package off of the cross belt sorter system). Similar to above, the drive belt(s) or drive chain(s) (whether made of plastic, metal, or some other material) that convey the carriages through the loop of the cross belt sorter system can likewise expand or contract, thereby detrimentally impacting sortation accuracy, control of the carriages in the loop, and tracking of packages on the carriages. Further, intermittent surging can likewise result due to expansion or contraction of the drive belt(s) and/or drive chain(s).

### SUMMARY

The following is a brief summary of subject matter that is described in greater detail herein. This summary is not intended to be limiting as to the scope of the claims.

According to various embodiments, a sorter system includes a frame. The sorter system further includes a conveying surface configured to move relative to the frame in a direction of conveyance. The conveying surface includes a plurality of timing sections spaced apart from each other with known pitches between adjacent timing sections. Each of the timing sections include a marker (or a plurality of markers). A plurality of sensors are fixed along a length of the frame, where the sensors are configured to output trigger signals at times that markers of the timing sections are proximate the sensors as the conveying surface moves relative to the frame. The sorter system also includes a control system configured to detect a first offset between a package and a particular marker based on the trigger signals, detect a second offset between the particular marker and a destination for the package based on the trigger signal, and cause the conveying surface to divert the package in a direction perpendicular to the direction of conveyance based on the first offset and the second offset.

Pursuant to various embodiments, a method of controlling a sorter system includes causing a conveying surface of the sorter system to move relative to a frame of the sorter system in a direction of conveyance. The conveying surface includes a plurality of timing sections spaced apart from each other with known pitches between adjacent timing sections, where each of the timing sections comprises a marker. The method further includes receiving trigger signals outputted from sensors fixed along a length of the frame, where the trigger signals are outputted at times that markers of the timing sections are proximate the sensors as the conveying surface moves relative to the frame; Moreover, the method includes detecting a first offset between a package and a particular marker based on the trigger signals. The method also includes detecting a second offset between the particular marker and a destination for the package based on the trigger signal. Further, the method includes causing the conveying surface to divert the package in a direction perpendicular to the direction of conveyance based on the first offset and the second offset.

This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments. Embodiments and other features and advantages of the present disclosure will be described and explained with additional specificity and detail through the use of the accompanying drawings in which:

FIG. 1 illustrates a top view of an exemplary sorter system according to various embodiments.

FIG. 2 illustrates a top view of an exemplary activated roller belt conveyor system (e.g., an embodiment of the sorter system of FIG. 1).

FIG. 3 illustrates a top view of an exemplary portion of an activated roller belt of the activated roller belt conveyor system of FIG. 2, where the portion of the belt lacks a timing section.

FIG. 4 illustrates a top view of another exemplary portion of the activated roller belt of the activated roller belt conveyor system of FIG. 2, where the portion of the belt includes a timing section.

FIG. 5 illustrates a top view of an exemplary sorter bed module of the activated roller belt conveyor system of FIG. 2.

FIG. 6 illustrates a top view of an exemplary portion of another embodiment of an activated roller belt of the activated roller belt conveyor system of FIG. 2.

FIG. 7 illustrates a perspective view of an exemplary cross belt sorter system (e.g., another embodiment of the sorter system of FIG. 1).

FIG. 8 illustrates an enlarged view of a portion of the cross belt sorter system of FIG. 7.

FIGS. 9-10 illustrate various views of the marker and the sensor included in the portion of the cross belt sorter system depicted in FIG. 8.

FIGS. 11-12 illustrate exemplary operation of a control system of the sorter system of FIG. 1.

### DETAILED DESCRIPTION

The following description refers to the accompanying drawings, which illustrate specific embodiments of the present disclosure. Other embodiments having different structures and operation do not depart from the scope of the present disclosure. The description and drawings are not intended to limit the scope of the invention in any manner.

“A” and “an” as used herein indicate “at least one” of the item is present; a plurality of such items may be present, when possible. As used herein, “substantially” means “to a considerable degree,” “largely,” or “proximately” as a person skilled in the art in view of the instant disclosure would understand the term. Spatially relative terms, such as “front,” “back,” “inner,” “outer,” “bottom,” “top,” “horizontal,” “vertical,” “upper,” “lower,” “side,” “up,” “down,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

It will be understood that the term “package” is not limited to a box containing items, but also encompasses any item or article which may be conveyed along a conveyor system.

Described herein are various technologies pertaining to control of a sorter system. More particularly, the approaches set forth herein can improve sortation accuracy of a sorter system relative to techniques implemented by conventional sorter systems. Some of the examples set forth herein describe the sorter system being an activated roller belt conveyor system; a conveying surface of an activated roller belt conveyor system includes an activated roller belt. Other examples set forth herein describe the sorter system being a cross belt sorter system; a conveying surface of a cross belt sorter system includes a plurality of carriages. However, it is to be appreciated that the approaches described herein can also be applied to other types of sorter systems, such as tilt tray sorter systems and the like.

Examples of cross belt sorter systems are set forth in U.S. patent application Ser. No. 18/476,242 (filed Sep. 27, 2023 and entitled “CROSS-BELT SORTER SYSTEM”) and U.S. patent application Ser. No. 18/941,564 (filed Nov. 8, 2024 and entitled “CROSS-BELT SORTER SYSTEM”). The entireties of the foregoing applications are incorporated herein by reference.

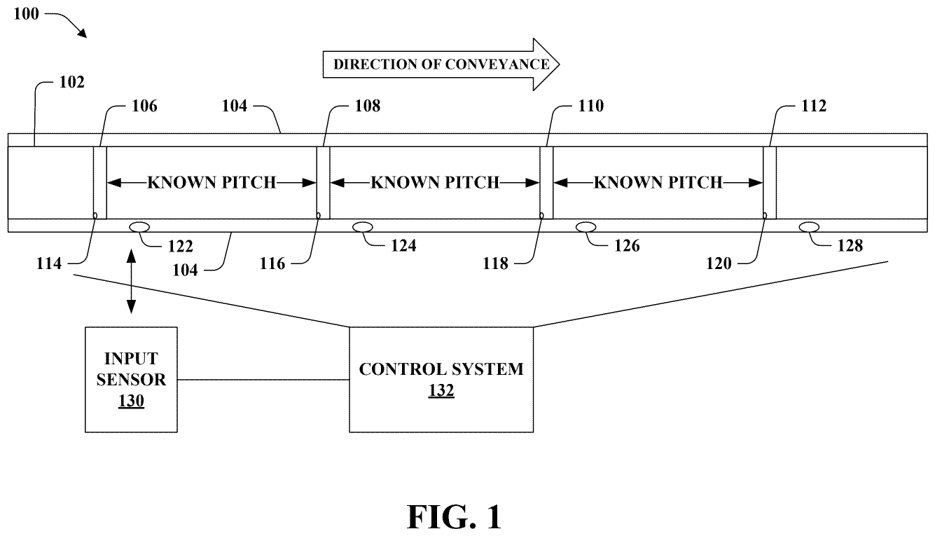

Now turning to FIG. 1, illustrated is a top view of an exemplary sorter system 100. As noted above, the sorter system 100 can be implemented as an activated roller belt conveyor system. In other embodiments, the sorter system 100 can be implemented as a cross belt sorter system. However, in other embodiments, it is to be appreciated that the sorter system 100 can be implemented as a tilt tray sorter system or substantially any other type of sorter system.

The sorter system 100 includes a conveying surface 102 and a frame 104. The conveying surface 102 is configured to move relative to the frame 104. For instance, during operation of the sorter system 100, the frame 104 can be stationary, while the conveying surface 102 is configured to move relative to the stationary frame 104.

According to an embodiment where the sorter system 100 is an activated roller belt conveyor system, the conveying surface 102 can include an activated roller belt. The activated roller belt can be made of plastic links. However, it is contemplated that other types of belts are intended to fall within the scope of the hereto appended claims.

Pursuant to an embodiment where the sorter system 100 is a cross belt sorter system, the conveying surface 102 can include a plurality of carriages. The carriages can be coupled to a drive belt, a drive chain or the like (or a plurality of drive belts, drive chains, etc.). The term “mechanical power transmission element” is used herein to refer to a drive belt, a drive chain, or the like. Thus, the carriages are coupled to one or more mechanical power transmission elements configured to cause the carriages to move in a direction of conveyance relative to the frame 104. A mechanical power transmission element can be made of plastic, metal, or the like.

The conveying surface 102 includes a plurality of timing sections 106, 108, 110, and 112 (collectively referred to herein as timing sections 106-112) that are spaced apart from each other with known pitches between adjacent timing sections 106-112. Thus, a pitch between the timing section 106 and the timing section 108 is known, a pitch between the timing section 108 and the timing section 110 is known, and so forth. According to an example, at least a subset of the known pitches can be consistent (e.g., the pitch between the timing section 106 and the timing section 108 can be the same as the pitch between the timing section 108 and the timing section 110). By way of illustration, all (or most) of the known pitches along the conveying surface 102 can be consistent. Additionally or alternatively, at least a subset of the known pitches can differ from one another (e.g., the pitch between the timing section 108 and the timing section 110 can differ from the pitch between the timing section 110 and the timing section 112). Moreover, it is contemplated that the conveying surface 102 can include substantially any number of timing sections 106-112.

For example, the timing sections 106-112 can be timing belt sections of an activated roller belt. According to another example, the timing sections 106-112 can be carriages (e.g., a subset of the carriages included in a cross belt sorter system).

The timing sections 106-112 include respective markers. As illustrated, the timing section 106 includes a marker 114, the timing section 108 includes a marker 116, the timing section 110 includes a marker 118, and the timing section 112 includes a marker 120 (collectively referred to herein as markers 114-120). It is contemplated that each timing section 106-112 can respectively include one marker 114-120 as depicted in FIG. 1. However, in other examples, it is contemplated that each timing section 106-112 can include more than one marker 114-120; for instance, the timing section 106 can include two markers disposed near opposite sides of the conveying surface 102 across the width of the conveying surface 102 as opposed to a single marker 114 disposed near one side of the conveying surface 102 as depicted in FIG. 1. Moreover, it is also contemplated that a subset of the timing sections 106-112 can include one marker 114-120, while other timing sections 106-112 can include more than one marker 114-120.

The frame 104 of the sorter system 100 includes a plurality of sensors 122, 124, 126, and 128 along its length (collectively referred to as sensors 122-128). Distances between adjacent sensors 122-128 along the length of the frame 104 are known. The sensors 122-128 can be implemented as proximity sensors (e.g., proximity switches) configured to detect the presence of the markers 114-120 respectively nearby. The proximity sensors can be inductive, capacitive, or magnetic proximity sensors. According to other examples, the sensors 122-128 can be implemented as optical or photoelectric sensors. The sensors 122-128 can output trigger signals at times the markers 114-120 are proximate to the sensors 122-128 as the conveying surface 102 moves relative to the frame 104 in the direction of conveyance (e.g., the sensor 128 can output a trigger signal at a time the marker 120 is proximate, then can output a trigger signal at a time the marker 118 is proximate, etc.).

Pursuant to an illustration, the markers 114-120 can be metallic objects included in and/or coupled to the conveying surface 102. Following this illustration, the proximity sensors can sense the metallic objects being nearby without physical contact occurring.

According to an illustration, the markers 114-120 can be disposed approximately every 10-15 feet (e.g., the known pitches) along the conveying surface 102. In contrast, some conventional approaches utilize a single marker for an entire length of a conveying surface and a single sensor. Relative locations of the markers 114-120 along the conveying surface 102 can be based on a number of links or belt pitch. According to another example, relative locations of the markers 114-120 along the conveying surface 102 can be based on a number of carriages.

Use of a plurality of markers 114-120 along the conveying surface 102 allows for simultaneously recalibrating length within sections of the conveying surface 102 between adjacent markers 114-120. Stretching or contraction of an activated roller belt (of an activated roller belt conveyor system) or a mechanical power transmission element (of a cross belt sorter system) can be tracked on short time scales (e.g., time corresponding to the conveying surface 102 being moved such that a marker traverses from being proximate to one of the sensors 122-128 to being proximate to a next one of the sensors 122-128). Further, the stretching or contraction within each of the sections of the conveying surface 102 can be simultaneously recalibrated across the full length of the conveying surface 102.

Each desired sortation destination can be linked to a nearest upstream sensor 122-128. The foregoing can mitigate calculating or estimating positions from a home base location, which can be up to on the order of 150 feet away from a sortation destination in conventional approaches. Moreover, a package can be linked to a downstream marker 114-120; for instance, an offset between a position of a package and a closest downstream marker 114-120 can be detected upon the package entering the sorter system 100.

The sorter system 100 further includes an input sensor 130 and a control system 132. The input sensor 130 can be configured to detect a package entering the sorter system 100 (e.g., at induct to the sorter system 100). Further, the offset between the position of the package as detected by the input sensor 130 and the closest downstream marker 114-120 can be identified by the control system 132. For instance, the input sensor 130 can be an optical sensor (e.g., a camera), a photoelectric sensor, or the like; however, the claimed subject matter is not so limited. The input sensor 130 can be aligned with the first sensor 122 on an infeed end of the sorter system 100. The input sensor 130 can be configured to detect a leading edge of a package breaking a plane at a location of the first sensor 122.

The sensors 122-128 can have unique identifiers that allow for tighter monitoring against known mileposts along the length of the sorter system 100. Positions of packages can be measured relative to a nearest downstream marker 114-120 (e.g., a nearest downstream timing section 106-112), and the nearest downstream markers 114-120 can register against the mileposts (e.g., the sensors 122-128) for tighter precision of activation (e.g., of the activated roller belt, of a carriage) and sorting.

Moreover, the control system 132 can be configured to control a speed of the conveying surface 102, track locations of packages on the conveying surface 102, and control package diverts off of the conveying surface 102. The control system 132 is configured to detect a first offset between a package and a marker. The control system 132 is further configured to detect a second offset between the marker and a destination for the package. The control system 132 causes the package to be diverted off of the conveying surface 102 based on the first offset and the second offset (e.g., the package can be diverted in a direction perpendicular to the direction of conveyance). The control system 132 is described in more detail below.

Many of the embodiments set forth herein describe the sorter system 100 including a plurality of markers 114-120 and a plurality of sensors 122-128. However, according to other embodiments, the sorter system 100 can include only one marker and a plurality of sensors. In accordance with yet other embodiments, the sorter system 100 can include a plurality of markers and only one sensor.

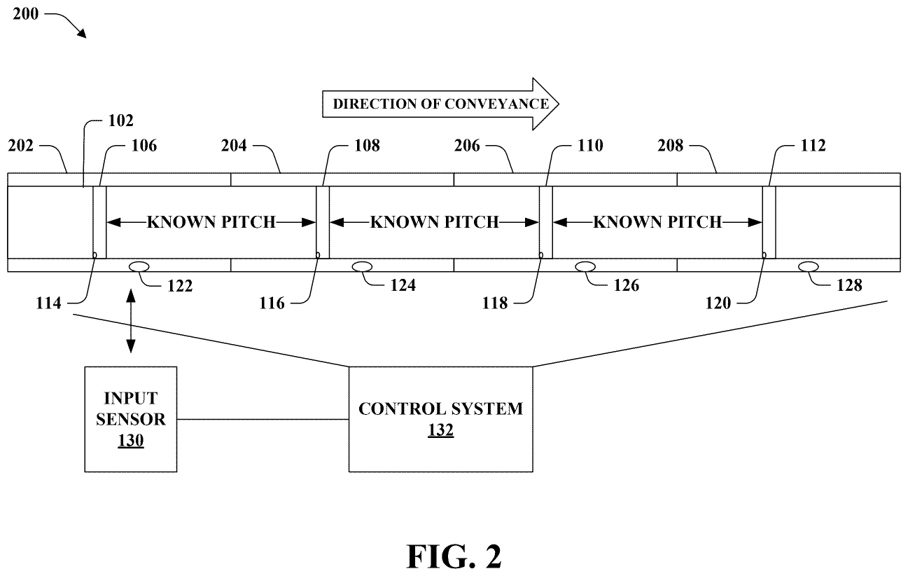

Now turning to FIG. 2, illustrated is a top view of an exemplary activated roller belt conveyor system 200 (e.g., the sorter system 100 is an activated roller belt conveyor system). The activated roller belt conveyor system 200 includes the conveying surface 102; the conveying surface 102 is an activated roller belt in the example of FIG. 2. Moreover, the frame of the activated roller belt conveyor system 200 includes a plurality of sorter bed modules. In the illustrated example, the activated roller belt conveyor system 200 includes a sorter bed module 202, a sorter bed module 204, a sorter bed module 206, and a sorter bed module 208 (collectively referred to herein as sorter bed modules 202-208). While four sorter bed modules 202-208 are illustrated in FIG. 2, it is to be appreciated that the activated roller belt conveyor system 200 can include substantially any number of sorter bed modules 202-208.

In the illustrated example, the sorter bed modules 202-208 include respective sensors. As depicted in FIG. 2, the sorter bed module 202 includes the sensor 122, the sorter bed module 204 includes the sensor 124, the sorter bed module 206 includes the sensor 126, and the sorter bed module 208 includes the sensor 128. It is contemplated that each sorter bed module 202-208 can respectively include one sensor 122-128 as depicted in FIG. 2. However, in other examples, it is contemplated that each sorter bed module 202-208 can include more than one sensor 122-128. Following the example noted above in connection with FIG. 1 where the timing sections 106-112 include two markers disposed near opposite sides of the conveying surface 102, it follows that the sorter bed modules 202-208 can each include two sensors disposed near opposite sides of the sorter bed modules 202-208 rather than a single sensor disposed near one side as shown in FIG. 2. Further, it is contemplated that at least a subset of the sorter bed modules 202-208 can lack a sensor in other embodiments.

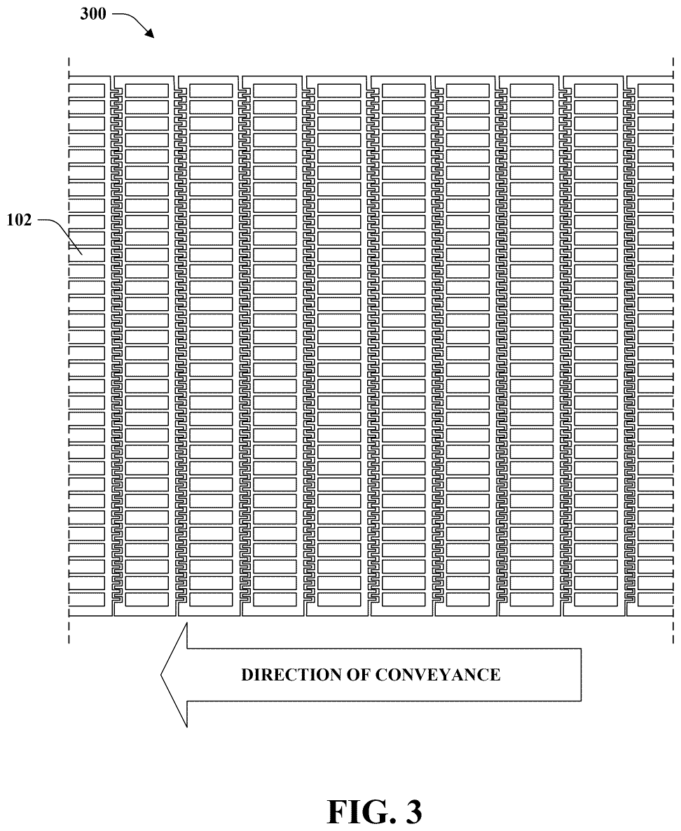

Now turning to FIG. 3, illustrated is a top view of an exemplary portion 300 of the conveying surface 102 (e.g., the activated roller belt) of the activated roller belt conveyor system 200. The portion 300 of the conveying surface 102 depicted in FIG. 3 lacks a timing section (and thus, lacks a marker). As depicted, the conveying surface 102 of FIG. 3 includes rollers that can be activated (by a sorter bed module below the activated roller belt) to move a package perpendicular to a direction of conveyance.

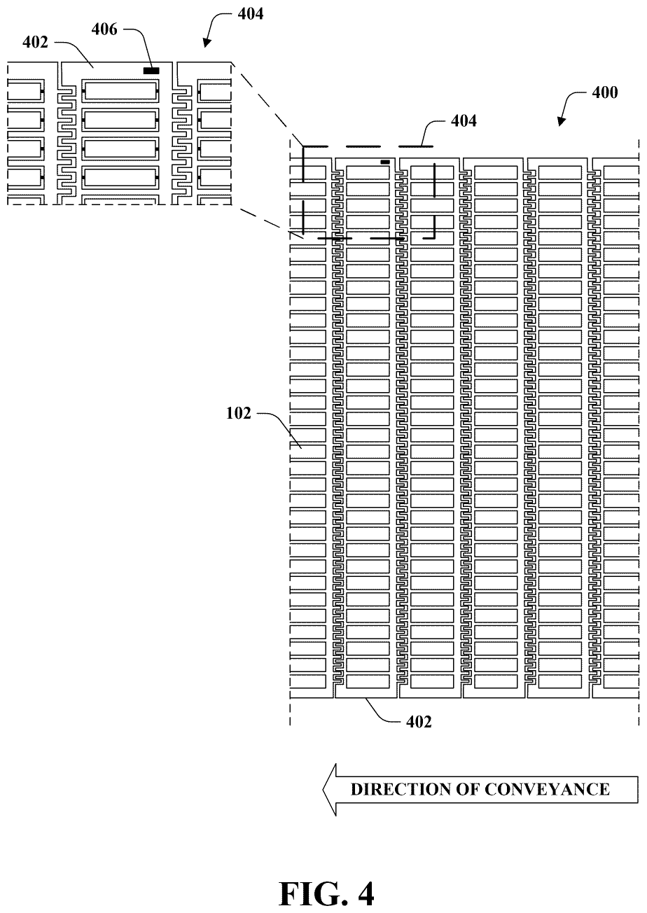

Referring now to FIG. 4, illustrated is a top view of another exemplary portion 400 of the conveying surface 102 (e.g., the activated roller belt) of the activated roller belt conveyor system 200. Again, the conveying surface 102 depicted in FIG. 4 includes rollers that can be activated (by a sorter bed module below the activated roller belt) to move a package perpendicular to a direction of conveyance. The portion 400 of the conveying surface 102 shown in FIG. 4 includes a timing section 402 (e.g., one of the timing sections 106-112). FIG. 4 also depicts an exploded view 404 of the timing section 402 from the portion 400 of the conveying surface 102 near a side of the conveying surface 102. As illustrated, the exploded view 404 depicts a marker 406 being included in the timing section 402 near a first side of the conveying surface 102. In the embodiment shown in FIG. 4, a second side of the timing section 402 of the conveying surface 102 across a width of the conveying surface 102 opposite of the first side lacks a marker (e.g., the width of the conveying surface 102 is perpendicular to the direction of conveyance).

The marker 406 can be one of the markers 114-120. According to an example, the marker 406 can be a metallic object included within the conveying surface 102. Such a metallic object can be mounted within a plastic belt link of the activated roller belt. The metallic object can be a rectangular prism that is positioned within the plastic belt link of the activated roller belt, for instance.

According to various embodiments, in contrast to conventional approaches that employ a single timing section (with a single marker within the single timing section) and a single sensor for detecting the single marker being within proximity, the conveying surface 102 can include the plurality of timing sections 106-112 that include the plurality of markers 114-120 along the conveying surface 102.

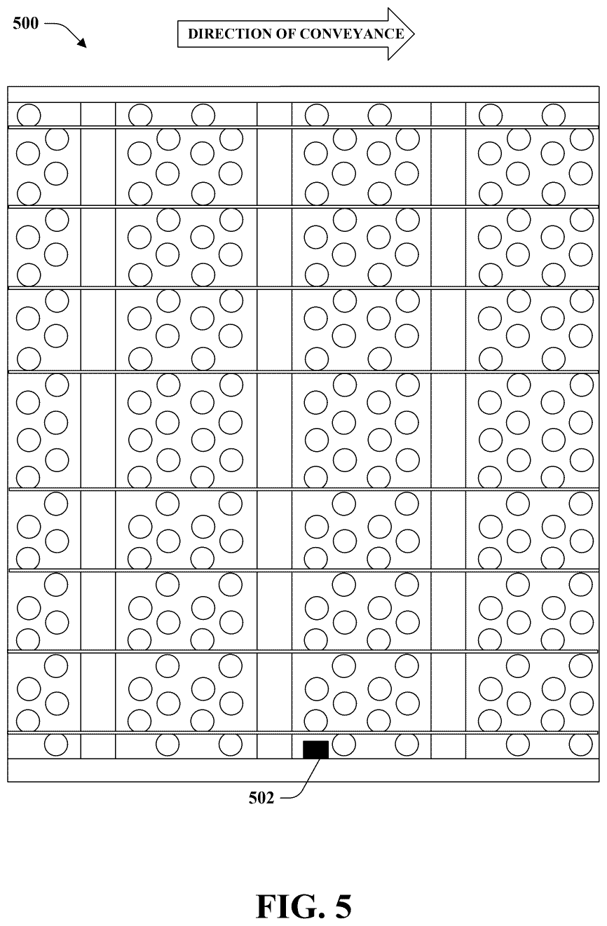

With reference to FIG. 5, illustrated is a top view of a portion of an exemplary sorter bed module 500 of the activated roller belt conveyor system 200 (e.g., one of the sorter bed modules 202-208). The sorter bed module 500 includes a sensor 502. The sensor 502 can be a proximity sensor; thus, the sensor 502 can detect when the marker 406 of FIG. 4 is proximate to the sensor 502 as the conveying surface 102 (e.g., the activated roller belt) is moved relative to the sorter bed module 500.

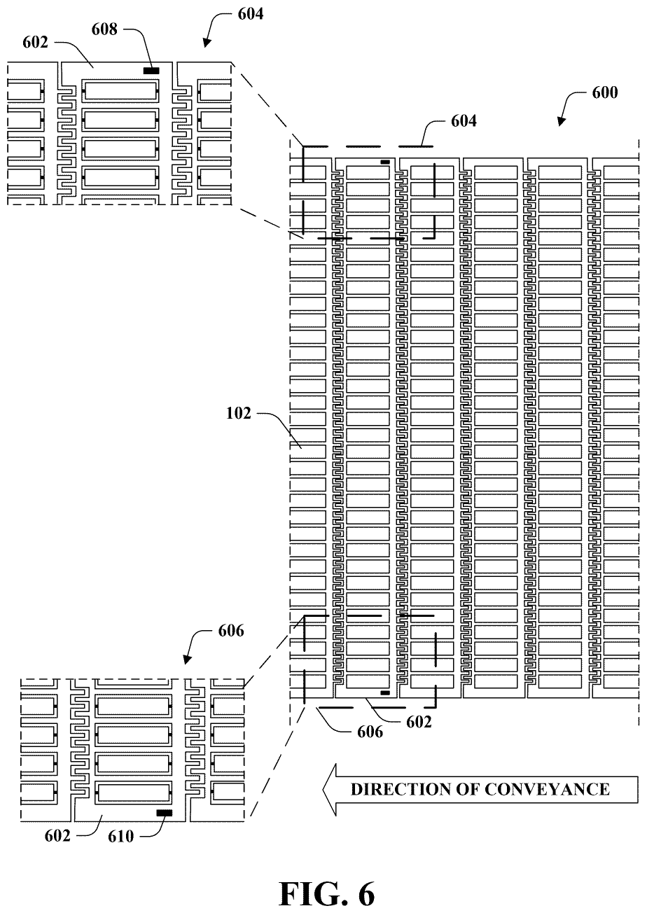

FIG. 6 illustrates a top view of an exemplary portion 600 of the conveying surface 102 (e.g., the activated roller belter) of the activated roller belt conveyor system 200 pursuant to another embodiment. Similar to above, the conveying surface 102 includes rollers that can be activated (by a sorter bed module below the activated roller belt) to move a package perpendicular to a direction of conveyance. The portion 600 of the conveying surface 102 shown in FIG. 6 includes a timing section 602 (e.g., one of the timing sections 106-112). FIG. 6 includes exploded view 604 and exploded view 606. The exploded view 604 depicts a marker 608 being included in the timing section 602 near a first side of the conveying surface 102 and the exploded view 606 depicts a marker 610 being included in the timing section 602 near a second side of the conveying surface 102, where the first side and the second side are opposite of each other across the width of the conveying surface 102. The markers 608 and 610 can each be substantially similar to the marker 604 of FIG. 4. A sorter bed module used with the conveying surface 102 of FIG. 6 can include two sensors across the width of sorter bed module (e.g., each similar to the sensor 502 of FIG. 5).

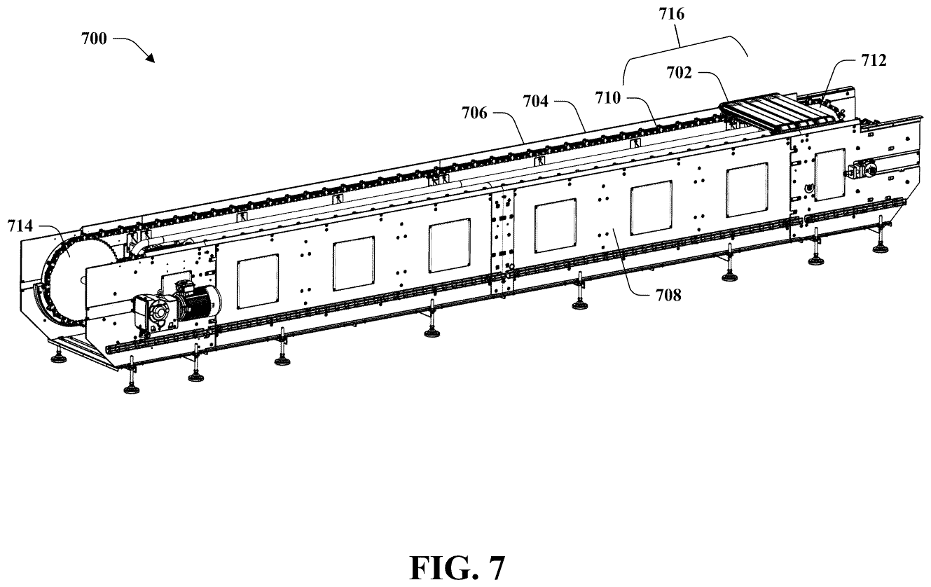

With reference to FIG. 7, illustrated is a perspective view of an exemplary cross belt sorter system 700 (e.g., the sorter system 100 is a cross belt sorter system). The cross belt sorter system 700 includes a conveying surface (e.g., the conveying surface 102), which includes a plurality of carriages (such as a carriage 702). For purposes of visibility, many of the carriages of the cross belt sorter system 700 are removed in the drawings. The cross belt sorter system 700 also includes a frame 704. The carriages extend between a first side 706 and a second side 708 of the frame 704.

The carriages are coupled to a mechanical power transmission element 710 near the first side 706 of the frame 704. Although not shown, the carriages are also coupled to a second mechanical power transmission element near the second side 708 of the frame 704 (the second mechanical power transmission element can be similar to the mechanical power transmission element 710).

The cross belt sorter system 700 further includes sprockets. A first shaft can drive a first set of sprockets (e.g., a first sprocket 712 near the first side 706 of the frame 704 and a second sprocket near the second side 708 of the frame 704) and a second shaft can drive a second set of sprockets (e.g., a third sprocket 714 near the first side 706 of the frame 704 and a fourth sprocket near the second side 708 of the frame 704). Rotation of the first sprocket 712 and the third sprocket 714 can cause movement of the mechanical power transmission element 710. Likewise, rotation of the second sprocket and the fourth sprocket can cause movement of the second mechanical power transmission element. Movement of the mechanical power transmission element 710 and the second mechanical power transmission element in turn causes movement of the carriages in the direction of conveyance.

The carriages further include respective top surfaces configured to move in a direction perpendicular to the direction of conveyance across the width of the cross belt sorter system (e.g., the top surface can be moved to divert a package off of the cross belt sorter system 700). Movement of the top surfaces of the carriages can be controlled by the control system 132 to cause a package to be moved in a direction perpendicular to the direction of conveyance; for instance, a package on the conveying surface can be diverted over the first side 706 of the frame 704 or over the second side 708 of the frame 704, such as into a chute or receptable.

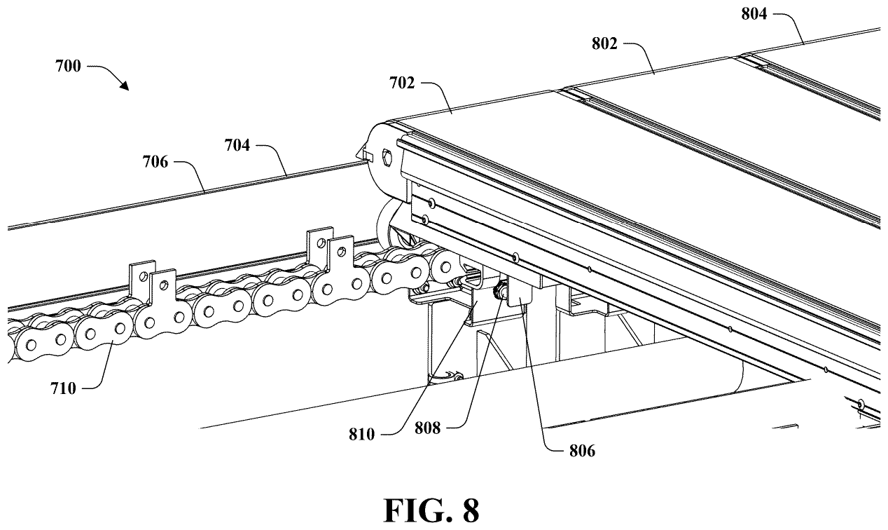

Moreover, a portion 716 of the cross belt sorter system 700 of FIG. 7 is enlarged in FIG. 8. FIG. 8 depicts portions of three carriages included in the cross belt sorter system 700, namely, the carriage 702, a carriage 802, and a carriage 804. Again, carriages are removed in FIG. 8 for purposes of visibility. Also shown is a part of the first side 706 of the frame 704 and a portion of the mechanical power transmission element 710.

The carriage 702 is one of the timing sections 106-112. More particularly, the carriage 702 includes a marker 806 (e.g., one of the markers 114-120). The marker 806 is coupled to a bottom of the carriage 702 and extends downwards from the carriage 702. The marker 806, for instance, can be formed of metal; however, in other embodiments, the marker 806 can be formed of other materials, such as plastic. A subset of the carriages of the cross belt sorter system 700 can be timing sections 106-112 that include markers similar to the marker 806.

Moreover, the frame 704 includes a sensor 808 (e.g., one of the sensors 122-128). A bracket 810 can be coupled to the first side 706 of the frame 704, and the sensor 808 can be coupled to the bracket 810. The sensor 808 can be a proximity sensor configured to detect the presence of markers (e.g., the marker 806, other markers included in the cross belt sorter system 700). Accordingly, a plurality of sensors, each substantially similar to the sensor 808, can be disposed along a length of the frame 704.

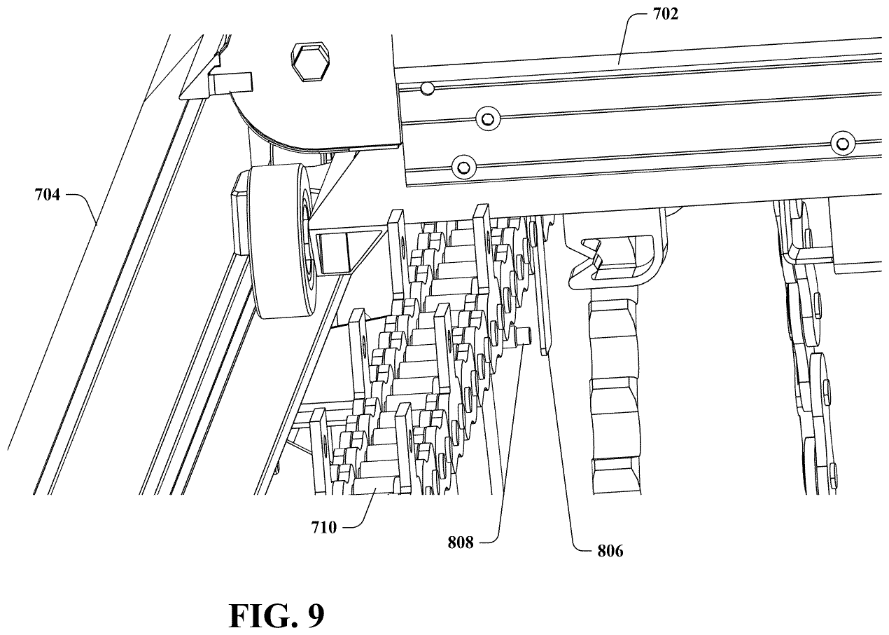

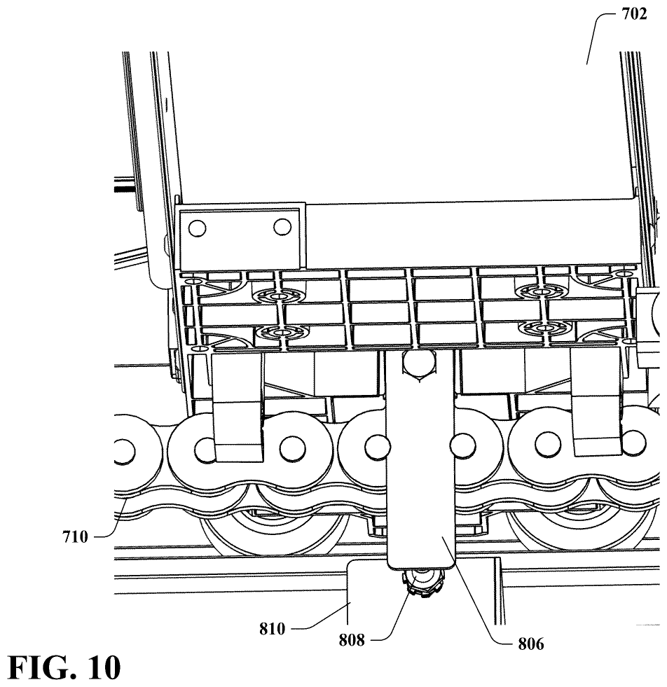

Additional views of the marker 806 and the sensor 808 from FIG. 8 are shown in FIGS. 9-10. FIG. 9 depicts a side view of the marker 806 and the sensor 808. FIG. 10 shows the bottom of carriage 702; again, the marker 806 is coupled to the bottom of the carriage 702 and extends downwards from the carriage 702. The carriage 702 and the marker 806 are further coupled to the mechanical power transmission element 710. The sensor 808 can be configured to output a trigger signal at a time the marker 806 is proximate to the sensor 808 (when the marker 806 passes in front of the sensor 808 with the relative positioning shown in FIGS. 8-10).

Reference is now generally made to FIGS. 1-10. In some conventional approaches, a conveying surface having a single timing section may be employed with a sensor in a traditional sorter system. A tracking program can be used to monitor and control package diverts off of the traditional sorter system. The tracking program can first image the package at induct to the sorter system and then rely on conveying surface pitch and speed of the conveying surface to calculate package position. These conventional approaches typically include a single marker and a sensor (e.g., a marker may be in one master link without the conveying surface including any other markers). As the marker travels the length of the conveying surface, the marker trips the sensor of the sorter system when proximate to each other. By knowing the speed of conveying surface travel (commanded by a variable frequency drive (VFD) and measured by an encoder) and time in between subsequent sensor trippings, properties such as length of the conveying surface (e.g., belt length) can be directly measured. However, since the marker is within a single timing section (within a single master link) per full conveying surface (e.g., the conveying surface includes only one marker), sortation accuracy can be detrimentally impacted along the length of the conveying surface of a traditional sorter system.

In contrast to the conventional approaches, the control system 132 of the sorter system 100 can utilize substantially less estimation and can have more reliance on actual measurements from the sensors 122-128; thus, the sorter system 100 can provide greater reliability relative to the traditional sorter system described above. Moreover, the control system 132 of the sorter system 100 that employs less estimation can run faster and can be less complicated relative to the traditional sorter system. Further, the control system 132 of the sorter system 100 can be more tolerant to changes in length, wear, etc. of a belt or mechanical power transmission element due to many simultaneous physical measurements taken constantly during one conveying surface revolution (e.g., based on the number of markers 114-120/timing sections 106-112) being employed. Accordingly, actual measurements of the conveying surface 102 can allow for detecting expansion and contraction along the length of the conveying surface 102 as opposed to modeling or predicting such changes along the length of the conveying surface 102. Thus, the control system 132 can provide improved sortation accuracy relative to traditional sorter systems.

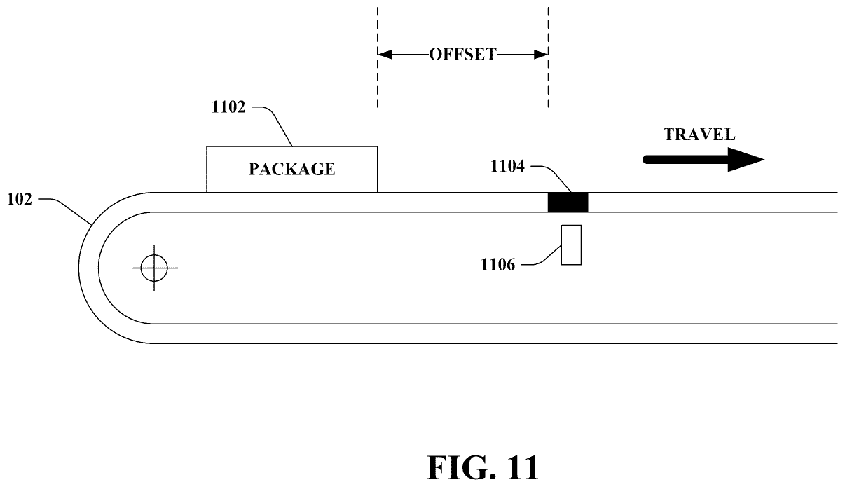

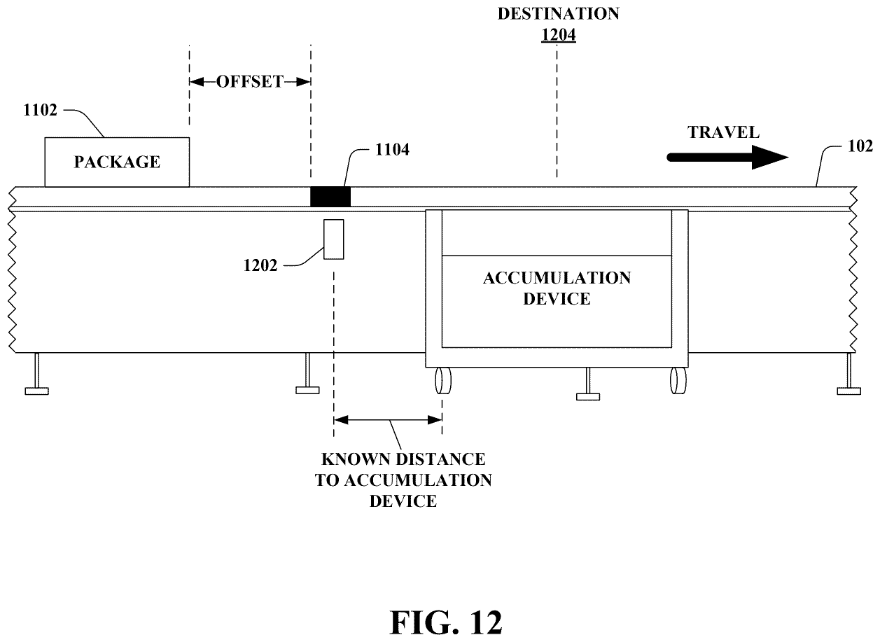

Operation of the control system 132 is further described in connection with FIGS. 11-12. FIG. 11 illustrates detection of an upstream offset of a package 1102 to a marker 1104 (e.g., one of the markers 114-120). The conveying surface 102 of the sorter system 100 is run until an infeed sensor 1106 (e.g., an infeed proximity sensor) senses the marker 1104. The infeed sensor 1106 is a first one of the sensors 122-128 at an infeed end of the sorter system 100.

The control system 132 can be configured to count encoder pulses until a leading edge of the package 1102 is detected. Based on the lapsed encoder pulses (and based on the speed of the conveying surface 102), the control system 132 can establish a distance as a package offset parameter; a value of the package offset parameter associated with the package 1102 can be stored in a tracking file for the package 1102. To effectuate the foregoing, the sorter system 100 includes a photo-eye (e.g., the input sensor 130) aligned with the first sensor 1106 on an infeed end of the sorter system 100. The photo-eye is configured to detect the leading edge of the package 502 breaking a plane at a location of the first sensor 1106.

Now referring to FIG. 12, illustrated is detection of a downstream offset of a sensor 1202 to a destination 1204. FIG. 12 again shows the upstream offset of the package 1102 to the marker 1104, which is determined as described in connection with FIG. 11.

Based on a location of a destination 1204, the control system 132 determines a distance from an upstream sensor 1202 to the desired destination 1204 for the package 1102. The destination 1204 can be any point to which it is desired to divert a package (e.g., an accumulation device, another conveyor, etc.). The distance can be adjusted for round robin loading. After the marker 1104 reaches the upstream sensor 1202, the package 1102 can be allowed to travel based on the encoder pulses matching the offset determined in connection with FIG. 11. Then, the control system 132 can cause the package 1102 to divert to the destination 1204.

According to an example, the control system 132 of the cross belt sorter system 700 can evaluate the following:

$$\frac{X}{Δ T} = ( {P}_{0} \cdot S ) \cdot N \cdot f$$

X is the distance between adjacent sensors 122-128, ΔT is time between triggers, P₀ is initial chain pitch, S is a stretch factor, N is a number of sprocket teeth, and f is a sprocket speed (revolutions/time).

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, alternatives as to form, fit, and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

Moreover, while various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

What is claimed is:

1. A sorter system, comprising:
a frame;
a conveying surface configured to move relative to the frame in a direction of conveyance, the conveying surface comprising a plurality of timing sections spaced apart from each other with known pitches between adjacent timing sections, wherein each of the timing sections comprises a marker;
a plurality of sensors fixed along a length of the frame, wherein the sensors are configured to output trigger signals at times that markers of the timing sections are proximate the sensors as the conveying surface moves relative to the frame; and
a control system configured to:
detect a first offset between a package and a particular marker based on the trigger signals;
detect a second offset between the particular marker and a destination for the package based on the trigger signal; and
cause the conveying surface to divert the package in a direction perpendicular to the direction of conveyance based on the first offset and the second offset.

2. The sorter system of claim 1, wherein the sorter system is an activated roller belt sorter system, and wherein the conveying surface is an activated roller belt.

3. The sorter system of claim 1, wherein the sorter system is a cross belt sorter system, and wherein the conveying surface comprises a plurality of carriages coupled to one or more mechanical power transmission elements.

4. The sorter system of claim 1, wherein the sensors are proximity sensors and the markers are metallic objects.

5. The sorter system of claim 1, further comprising:
an input sensor configured to detect a leading edge of the package, wherein the first offset is detected by the control system further based on output from the input sensor.

6. The sorter system of claim 5, wherein the control system is configured to count encoder pulses until the leading edge of the package is detected by the input sensor, wherein the first offset is detected based on the counted encoder pulses and a speed of the conveying surface.

7. The sorter system of claim 1, wherein the markers are coupled to a subset of carriages included in the conveying surface, and wherein the markers extend downwards from the carriages.

8. The sorter system of claim 1, wherein at least a subset of the known pitches along the conveying surface are consistent.

9. The sorter system of claim 1, wherein at least a subset of the known pitches differ from each other.

10. The sorter system of claim 1, wherein the control system is configured to simultaneously recalibrate length within sections of the conveying surface between adjacent markers.

11. The sorter system of claim 1, wherein the destination is linked to a nearest upstream sensor in the plurality of sensors.

12. The sorter system of claim 1, wherein the package is linked to a nearest downstream marker in the markers.

13. A method of controlling a sorter system, comprising:
causing a conveying surface of the sorter system to move relative to a frame of the sorter system in a direction of conveyance, the conveying surface comprising a plurality of timing sections spaced apart from each other with known pitches between adjacent timing sections, wherein each of the timing sections comprises a marker;
receiving trigger signals outputted from sensors fixed along a length of the frame, the trigger signals being outputted at times that markers of the timing sections are proximate the sensors as the conveying surface moves relative to the frame;
detecting a first offset between a package and a particular marker based on the trigger signals;
detecting a second offset between the particular marker and a destination for the package based on the trigger signal; and
causing the conveying surface to divert the package in a direction perpendicular to the direction of conveyance based on the first offset and the second offset.

14. The method of claim 13, wherein the sorter system is an activated roller belt sorter system, and wherein the conveying surface is an activated roller belt.

15. The method of claim 13, wherein the sorter system is a cross belt sorter system, and wherein the conveying surface comprises a plurality of carriages coupled to one or more mechanical power transmission elements.

16. The method of claim 13, wherein the sensors are proximity sensors and the markers are metallic objects.

17. The method of claim 13, further comprising:
detecting a leading edge of the package, wherein a first offset is detected based on the detected leading edge of the package.

18. The method of claim 13, further comprising:
simultaneously recalibrating length within sections of the conveying surface between adjacent markers.

19. The method of claim 13, wherein the destination is linked to a nearest upstream sensor in the plurality of sensors.

20. The method of claim 13, wherein the package is linked to a nearest downstream marker in the markers.
